(19) United States
(12) Patent Application Publication
(10) Pub. No.: US 2016/0063405 A1
(43) Pub. Date: Mar. 3, 2016

(54) PUBLIC TRANSPORTATION FARE EVASION INFERENCE USING PERSONAL MOBILITY DATA

(71) Applicant: International Business Machines Corporation, Armonk, NY (US)

(72) Inventors: FRANCESCO CALABRESE, Castlenock (IE); FABIO PINELLI, Dunboyne (IE)

(21) Appl. No.: 14/472,586

(22) Filed: Aug. 29, 2014

(51) Int. Cl. G06Q 10/06; H04W 4/02

(52) U.S. Cl. CPC G06Q 10/0635; H04W 4/027; G06Q 2240/00

(57) ABSTRACT

Embodiments include fare evasion inference using personal mobility data in a public transportation system. Aspects include receiving personal mobility data and constructing a plurality of personal trajectories from the personal mobility data. Aspects also include mapping each of the plurality of personal trajectories to a route and time of the public transportation system and calculating an estimated occupancy for each route and time in the public transportation system based on a number of personal trajectories mapped to each route and time. Aspects further include comparing the estimated occupancy with a paying passenger data received from the public transportation system and assigning a score to each route and time in the public transportation system based on the comparison of the estimated occupancies and the paying passenger data, wherein the score is indicative of a probability of a fare evasion occurring.

### BACKGROUND

The present invention generally relates to fare evasion in a public transportation system, and more specifically, to fare evasion inference using personal mobility data in a public transportation system.

Public transportation systems use a variety of methods and systems for collecting fares from users of the transportation system. Over time these methods and systems have become more advanced in attempts to increase the revenue of the public transportation system and to reduce the occurrence of fare evasion (e.g., ticketless travelers). Despite the advances in fare collection systems, the problem of fare evasion remains significant. As a result, companies and municipalities that operate public transportation systems invest a large amount of money to prevent and detect frauds on the public transportation system.

Some currently available fare evasion detection methods and systems require the installation of specialty devices, such as high resolution cameras, on every vehicle in the public transportation system. These specialty devices are used to monitor the occupants of the vehicle and to ensure that each has purchased a ticket. Due to their configuration, such systems can be very expensive for a large fleet of vehicles. In addition, some currently available fare evasion detection methods and systems are only configured to detect passengers without tickets, and are not configured to detect passengers which pay for a shorter trip than the actual trip taken, e.g., a user buying a bus ticket for one stop and then staying on the bus for ten stops.

### SUMMARY

Embodiments include a computer system for fare evasion inference using personal mobility data in a public transportation system, the computer system including a server having a processor, the processor configured to perform a method. The method includes receiving personal mobility data and constructing a plurality of personal trajectories from the personal mobility data. The method also includes mapping each of the plurality of personal trajectories to a route and time of the public transportation system and calculating an estimated occupancy for each route and time in the public transportation system based on a number of personal trajectories mapped to each route and time. The method further includes comparing the estimated occupancy with a paying passenger data received from the public transportation system and assigning a score to each route and time in the public transportation system based on the comparison of the estimated occupancies and the paying passenger data, wherein the score is indicative of a probability of a fare evasion occurring.

Embodiments also include a computer program product for fare evasion inference using personal mobility data in a public transportation system, the computer program product including a computer readable storage medium having computer readable program code embodied therewith. The computer readable program code including computer readable program code configured to perform a method. The method includes receiving personal mobility data and constructing a plurality of personal trajectories from the personal mobility data. The method also includes mapping each of the plurality of personal trajectories to a route and time of the public transportation system and calculating an estimated occupancy for each route and time in the public transportation system based on a number of personal trajectories mapped to each route and time. The method further includes comparing the estimated occupancy with a paying passenger data received from the public transportation system and assigning a score to each route and time in the public transportation system based on the comparison of the estimated occupancies and the paying passenger data, wherein the score is indicative of a probability of a fare evasion occurring.

Embodiments further include a method for fare evasion inference using personal mobility data in a public transportation system. The method includes receiving personal mobility data and constructing a plurality of personal trajectories from the personal mobility data. The method also includes mapping each of the plurality of personal trajectories to a route and time of the public transportation system and calculating an estimated occupancy for each route and time in the public transportation system based on a number of personal trajectories mapped to each route and time. The method further includes comparing the estimated occupancy with a paying passenger data received from the public transportation system and assigning a score to each route and time in the public transportation system based on the comparison of the estimated occupancies and the paying passenger data, wherein the score is indicative of a probability of a fare evasion occurring.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of a computer system for use in practicing the teachings herein;

FIG. 2 illustrates a block diagram of a system for fare evasion inference using personal mobility data in a public transportation system in accordance with an embodiment;

FIG. 3 illustrates a flow diagram of a method for fare evasion inference using personal mobility data in a public transportation system in accordance with an embodiment;

FIG. 4 illustrates a block diagram of a system for fare evasion inference using personal mobility data in a public transportation system in accordance with another embodiment; and

FIG. 5 illustrates a flow diagram of a method for fare evasion inference using personal mobility data in a public transportation system in accordance with another embodiment.

### DETAILED DESCRIPTION

Methods and systems for fare evasion inference using personal mobility data in a public transportation system are provided. In exemplary embodiments, personal mobility data (e.g., telecommunications data) is used to infer frauds on public transportation systems without installing specialty devices or additional infrastructure in the public transportation system. Aspects include receiving personal mobility data from a telecommunications system and route data from the public transportation system and calculating an estimated occupancy for each route and time. The estimated occupancy is then compared against the number of paying passengers and a fare evasion score for each route and time is calculated. Based on the calculated fare evasion scores, the operator of the public transportation system is better able to allocate its existing resources to specific routes and times to find more fare evaders. In exemplary embodiments, the methods and systems for fare evasion inference using personal mobility data may be configured to operate in real-time or may be configured to run on a periodic schedule.

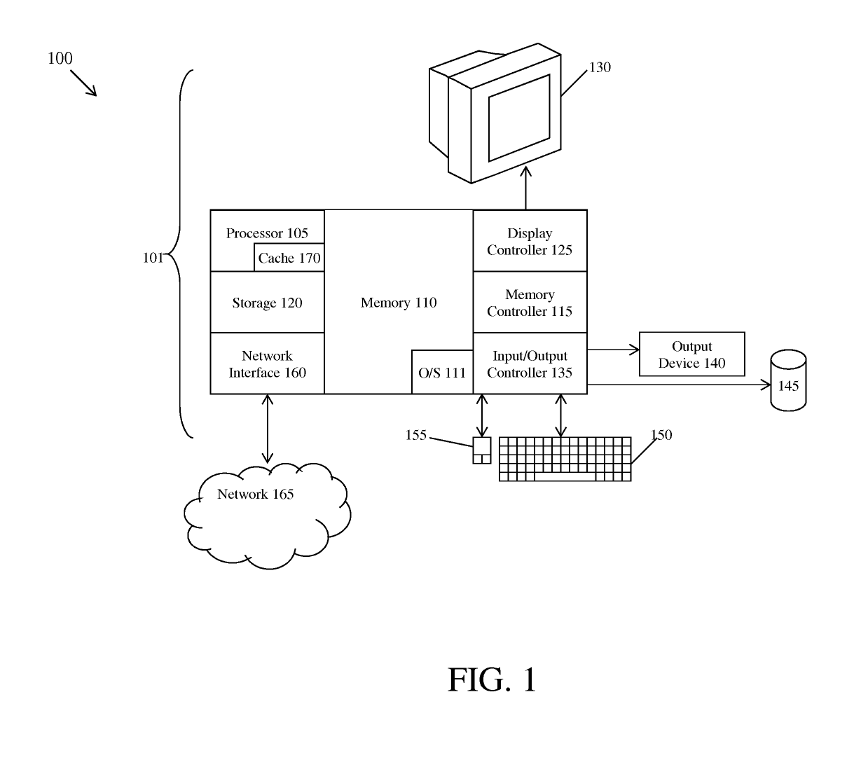

FIG. 1 illustrates a block diagram of a computer system 100 for use in practicing the teachings herein. The methods described herein can be implemented in hardware, software (e.g., firmware), or a combination thereof. In an exemplary embodiment, the methods described herein are implemented in hardware, and may be part of the microprocessor of a special or general-purpose digital computer, such as a personal computer, workstation, minicomputer, or mainframe computer. The computer system 100 therefore includes general-purpose computer 101.

In an exemplary embodiment, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions. The processor 105 includes a cache 170, which may include, but is not limited to, an instruction cache to speed up executable instruction fetch, a data cache to speed up virtual-to-physical address translation for both executable instructions and data. The cache 170 may be organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the hardware devices. The BIOS is stored in ROM so that the BIOS can be executed when the computer 101 is activated. When the computer 101 is in operation, the processor 105 is configured to execute instructions stored within the memory 110, to communicate data to and from the memory 110, and to generally control operations of the computer 101 pursuant to the instructions.

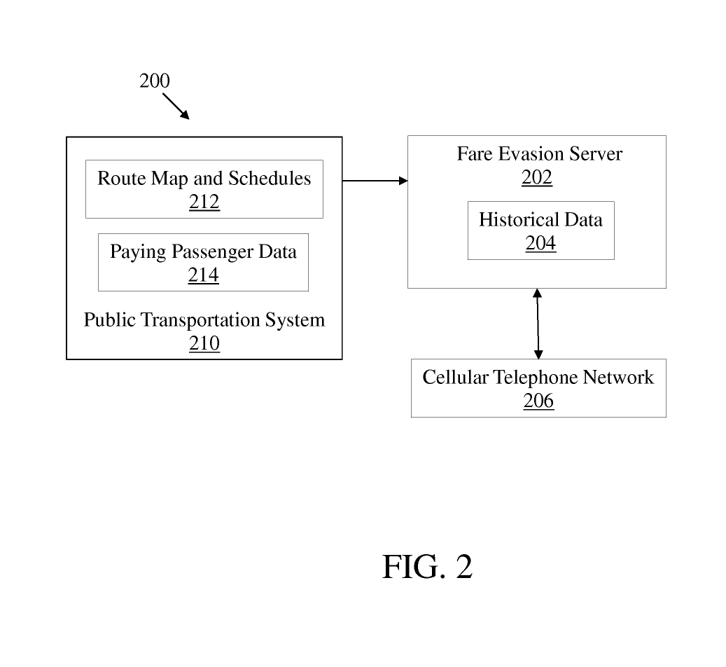

Referring now to FIG. 2, a block diagram of a system 200 for fare evasion inference using personal mobility data in a public transportation system in accordance with an embodiment is shown. As illustrated, the system 200 includes a fare evasion server 202, a cellular telephone network 206, and public transportation system 210. In exemplary embodiments, the fare evasion server 202 may be a computer system similar to that shown in FIG. 1. The fare evasion server 202 receives data from both the cellular telephone network 206 and from the public transportation system 210 that is used to calculate a probability of fare evasion on specific routes and times in the public transportation system 210.

In exemplary embodiments, the public transportation system 210 provides the fare evasion server 202 with paying passenger data 214 and with a route map and schedule 212 for the transportation equipment, also referred to as vehicles, in the public transportation system 210. The fare evasion server 202 also receives personal mobility data from the cellular telephone network 206. In exemplary embodiments, the personal mobility data may include an identification number and signal data for mobile communication devices that are in communication with the cellular telephone network 206. It will be appreciated by those of ordinary skill in the art that the personal mobility data may include a variety of additional information regarding the communication devices and that the signal data can be used to uniquely identify a communication device and to calculate the location of the communication device.

In exemplary embodiments, the fare evasion server 202 uses the received personal mobility data to identify one or more communication devices that are located on various pieces of transportation equipment in the public transportation system 210. Based on this information, the fare evasion server 202 calculates an estimate of the occupancy of each route and time of the public transportation system 210. In exemplary embodiments, the estimate is based on an assumption that the percentage of users of the public transportation system 210 that have communication devices, such as cell phones, is approximately constant. In exemplary embodiments, the estimated occupancy may be based on data received from all of the mobile phone operators in a geographic area or the estimate may be scaled based on the representativeness of the sample under analysis. For example, if data is only available from cellular networks which account for two thirds of the market, the estimated occupancy may be scaled appropriately.

In exemplary embodiments, the fare evasion server 202 compares the calculated estimated occupancy of each route and time of the public transportation system 210 with the corresponding paying passenger data 214 received from the public transportation system 210. Based on this comparison, the fare evasion server 202 calculates a score for each route and time of the public transportation system 210. In one embodiment, the score is a fare evasion ranking that is used to rank the probability of fare evasions on each route and time of the public transportation system 210. In another embodiment, the score is a fare evasion probability score that is indicative of the probability that a fare evasion is occurring on a given route and time of the public transportation system 210. Based on the calculated scores, the operator of the public transportation system 210 is better able to allocate its existing resources to specific routes at specific times to find more fare evaders.

In exemplary embodiments, the fare evasion server 202 stores historical data 204, such as historical fare collection and evasion statistics, in order to improve the accuracy of the provided fare evasion scores. For example, the fare evasion server 202 may uses the historical data to modify the calculated score to give more weight to routes where high fare evasion previously occurred. In addition, the historical data 202 can be used to approximate the actual occupancy in instance when the paying passenger data 214 is not available.

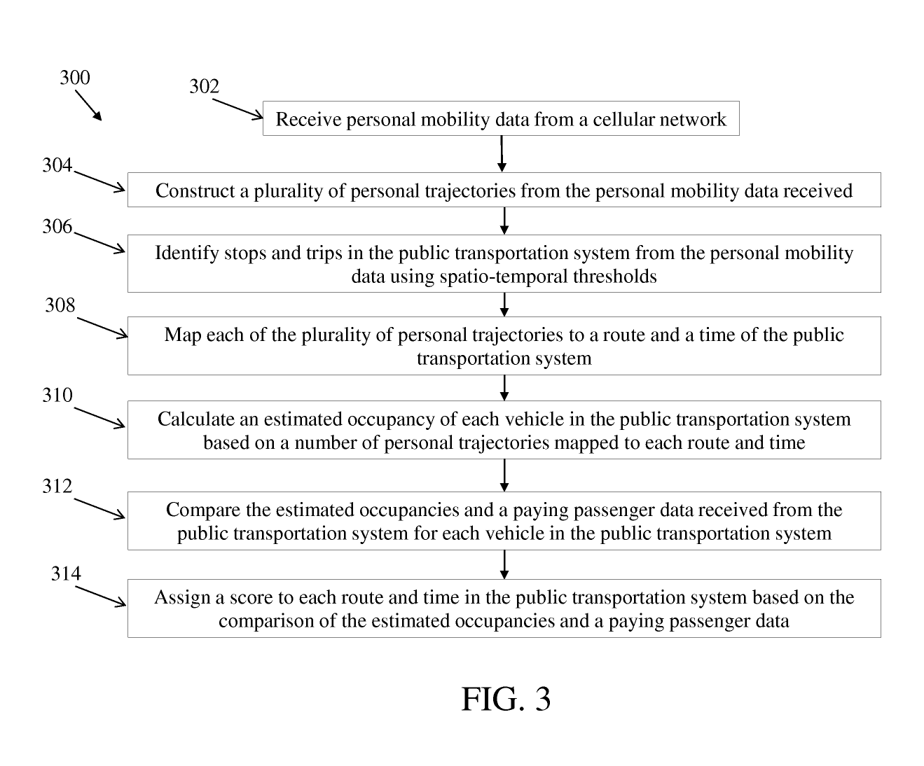

Referring now to FIG. 3, a flowchart diagram of a method 300 for fare evasion inference using personal mobility data in a public transportation system in accordance with an embodiment is shown. As shown at block 302, the method 300 includes receiving personal mobility data from a cellular network. Next, as shown at block 304, the method 300 includes constructing a plurality of personal trajectories from the personal mobility data received. In exemplary embodiments, a personal trajectory is a travel path of a single communication device, such as a cell phone. The method 300 also includes identifying stops and trips in the public transportation system from the personal mobility data using spatio-temporal thresholds, as shown at block 306. Next, as shown at block 308, the method 300 includes mapping each of the plurality of personal trajectories to a route and a time of the public transportation system. In exemplary embodiments, the mapping is obtained through the computation of a spatio-temporal measure of similarity, also referred to as a similarity score, between the calculated personal trajectory and each of the routes in the public transportation system. If the similarity score is below a minimal threshold, it is determined that the communications device is not located on the public transportation system. If the similarity score is above the minimal threshold, the communications device is determined to be located on a piece of transportation equipment that has a route and time associated with the highest similarity score.

Continuing with reference to FIG. 3, the method 300 also includes calculating an estimated occupancy of each vehicle in the public transportation system based on a number of personal trajectories mapped to each route and time, as shown at block 310. In exemplary embodiments, the estimated occupancy is based on an assumption that the percentage of users of the public transportation system that have communication devices on their person is approximately constant. Next, as shown at block 312, the method 300 includes comparing the estimated occupancies and a paying passenger data received from the public transportation system for each vehicle in the public transportation system. The method 300 also includes assigning a score to each route and time in the public transportation system based on the comparison of the estimated occupancies and a paying passenger data, as shown at block 314.

In exemplary embodiments, the method and systems for fare evasion inference using personal mobility data in a public transportation system may be configured to operate in real-time or may be configured to operate on a set periodic schedule. The operational mode of the fare evasion inference system may be based on whether the personal mobility data and the paying passenger data are made available to the fare evasion inference system in real-time.

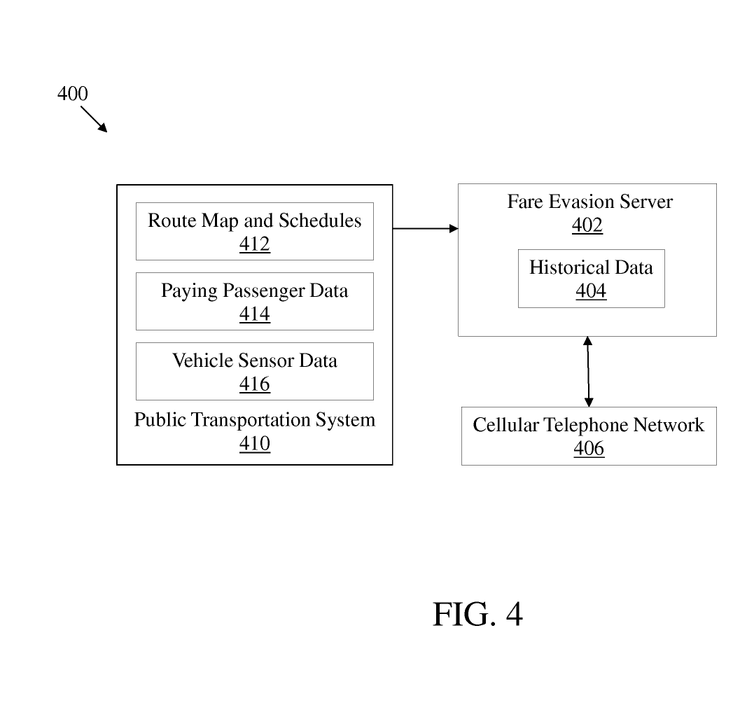

Referring now to FIG. 4, a block diagram of a system 400 for fare evasion inference using personal mobility data in a public transportation system in accordance with another embodiment is shown. As illustrated, the system 400 includes a fare evasion server 402, a cellular telephone network 406, and public transportation system 410. In exemplary embodiments, the fare evasion server 402 may be a computer system similar to that shown in FIG. 1. The fare evasion server 402 receives data from both the cellular telephone network 406 and from the public transportation system 410 that is used to calculate a probability of fare evasion on specific routes and times in the public transportation system 410.

In exemplary embodiments, the fare evasion server 402 also receives vehicle sensor data 416 from one or more vehicles in the public transportation system 410. The vehicle sensor data 416 is data received from one or more sensors located on transportation equipment of the public transportation system 410 that can be used to estimate the occupancy of the transportation equipment. In one embodiment the transportation equipment includes a WiFi or Bluetooth hotspot and the vehicle sensor data 416 may include a number of communications devices connected to the hotspot. In exemplary embodiments, the fare evasion server 402 may use the vehicle sensor data 416 in combination with the personal mobility data to calculate the estimated occupancy of a piece of transportation equipment of the public transportation system 410.

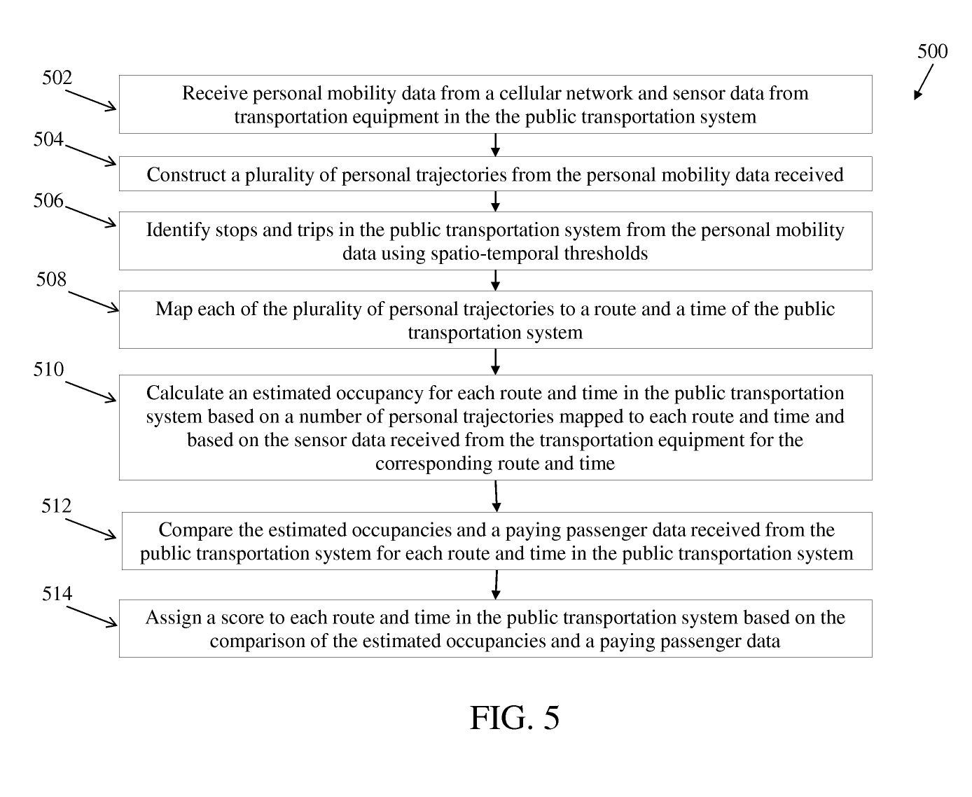

Referring now to FIG. 5, a flowchart diagram of a method 500 for fare evasion inference using personal mobility data in a public transportation system in accordance with another embodiment is shown. As shown at block 502, the method 500 includes receiving personal mobility data from a cellular network and sensor data from transportation equipment in the public transportation system. Next, as shown at block 504, the method 500 includes constructing a plurality of personal trajectories from the personal mobility data received. The method 500 also includes identifying stops and trips in the public transportation system from the personal mobility data using spatio-temporal thresholds, as shown at block 506. Next, as shown at block 508, the method 500 includes mapping each of the plurality of personal trajectories to a route and a time of the public transportation system.

Continuing with reference to FIG. 5, the method 500 also includes calculating an estimated occupancy for each route and time in the public transportation system based on a number of personal trajectories mapped to each route and time and based on the sensor data received from the transportation equipment for the corresponding route and time, as shown at block 510. Next, as shown at block 512, the method 500 includes comparing the estimated occupancies and a paying passenger data received from the public transportation system for each vehicle in the public transportation system. The method 500 also includes assigning a score to each route and time in the public transportation system based on the comparison of the estimated occupancies and a paying passenger data, as shown at block 514.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method for fare evasion inference using personal mobility data in a public transportation system, the method comprising:
receiving personal mobility data;
constructing, with a processing device, a plurality of personal trajectories from the personal mobility data;
mapping each of the plurality of personal trajectories to a route and time of the public transportation system;
calculating an estimated occupancy for each route and time in the public transportation system based on a number of personal trajectories mapped to each route and time;
comparing the estimated occupancy with a paying passenger data received from the public transportation system; and
assigning a score to each route and time in the public transportation system based on the comparison of the estimated occupancies and the paying passenger data, wherein the score is indicative of a fare evasion occurring, with an associated confidence level.

2. The method of claim 1, wherein the personal mobility data is received from a cellular network and includes data from a cellular network.

3. The method of claim 1, wherein the personal trajectory is a travel path of a single communication device.

4. The method of claim 1, wherein the mapping is obtained through a computation of a similarity score between the calculated personal trajectory of a communications device and each of the routes and times in the public transportation system.

5. The method of claim 4, wherein based on determining that the similarity score is above a minimal threshold, assigning the communications device to be located on a piece of transportation equipment that has a route and time associated with the highest similarity score.

6. The method of claim 1, further comprising receiving sensor data from one or more pieces of transportation equipment in the public transportation system.

7. The method of claim 6, wherein the estimated occupancy for each route and time in the public transportation system is further based on the sensor data received from the transportation equipment corresponding to the route and time.

8. The method of claim 1, further comprising receiving fare evasion statistics data from public transportation system.

9. The method of claim 1, further comprising receiving population demographic data.

10. The method of claim 1, wherein assigning a score to each route and time in the public transportation system is further based on fare evasion statistics data, and population demographic data.

11. A computer system for fare evasion inference using personal mobility data in a public transportation system, the computer system comprising:
a server having a processor, the processor configured to perform a method comprising:
receiving personal mobility data;
constructing a plurality of personal trajectories from the personal mobility data;
mapping each of the plurality of personal trajectories to a route and time of the public transportation system;
calculating an estimated occupancy for each route and time in the public transportation system based on a number of personal trajectories mapped to each route and time;
comparing the estimated occupancy with a paying passenger data received from the public transportation system; and
assigning a score to each route and time in the public transportation system based on the comparison of the estimated occupancies and the paying passenger data, wherein the score is indicative of a fare evasion occurring, with an associated confidence level.

12. The computer system of claim 11, wherein the personal trajectory is a travel path of a single communication device.

13. The computer system of claim 11, wherein the mapping is obtained through a computation of a similarity score between the calculated personal trajectory of a communications device and each of the routes and times in the public transportation system.

14. The computer system of claim 13, wherein based on determining that the similarity score is above a minimal threshold, assigning the communications device to be located on a piece of transportation equipment that has a route and time associated with the highest similarity score.

15. The computer system of claim 11, wherein the method further comprises receiving sensor data from one or more pieces of transportation equipment in the public transportation system.

16. The computer system of claim 15, wherein the estimated occupancy for each route and time in the public transportation system is further based on the sensor data received from the transportation equipment corresponding to the route and time.

17. A computer program product for fare evasion inference using personal mobility data in a public transportation system, the computer program product comprising:
a computer readable storage medium having computer readable program code embodied therewith, the computer readable program code comprising:
computer readable program code configured for:
receiving personal mobility data from a cellular network;
constructing a plurality of personal trajectories from the personal mobility data;
mapping each of the plurality of personal trajectories to a route and time of the public transportation system;
calculating an estimated occupancy for each route and time in the public transportation system based on a number of personal trajectories mapped to each route and time;
comparing the estimated occupancy with a paying passenger data received from the public transportation system; and
assigning a score to each route and time in the public transportation system based on the comparison of the estimated occupancies and the paying passenger data, wherein the score is indicative of a fare evasion occurring, with an associated confidence level.

18. The computer program product of claim 17, wherein the mapping is obtained through a computation of a similarity score between the calculated personal trajectory of a communications device and each of the routes and times in the public transportation system.

19. The computer program product of claim 18, wherein based on determining that the similarity score is above a minimal threshold, assigning the communications device to be located on a piece of transportation equipment that has a route and time associated with the highest similarity score.

20. The computer program product of claim 17, wherein the method further comprises receiving sensor data from one or more pieces of transportation equipment in the public transportation system.
